(19) United States
(12) Patent Application Publication
(10) Pub. No.: US 2009/0312877 A1
(43) Pub. Date: Dec. 17, 2009

(54) SYSTEM AND METHOD OF CONTROLLING HEAT DISSIPATION GATE

(76) Inventors: Tien Chi-Wei, Taipei City (TW); Shih Chang-Chiang, Taipei City (TW); Su Chien-Ming, Taipei City (TW); Wu Wen Yu, Taipei City (TW)

Correspondence Address: Muncy, Geissler, Olds & Lowe, PLLC, P.O. BOX 1364, FAIRFAX, VA, 22038-1364, US

(21) Appl. No.: 12/416,648

(22) Filed: Apr. 1, 2009

(30) Foreign Application Priority Data
Jun. 11, 2008 (TW) 97121725

(51) Int. Cl. G05D 7/00; F28F 27/00; F28D 21/00

(52) U.S. Cl. 700/282; 165/96; 165/121

(57) ABSTRACT

A heat dissipation gate control system includes a magnetic element, an electromagnetic element and an elastic element. The magnetic element is coupled to a heat dissipation gate. The electromagnetic element is provided for generating a magnetic force to enable the magnetic element to drive the heat dissipation gate open. The elastic element has an end coupled to the heat dissipation gate and applies an elastic force to the heat dissipation gate to enable the heat dissipation gate closed when the electromagnetic element stops generating the magnetic force for the magnetic element. A method of controlling a heat dissipation gate is also disclosed herein.

### RELATED APPLICATIONS

This application claims priority to Taiwan Patent Application Serial Number 97121725, filed Jun. 11, 2008, which is herein incorporated by reference.

### BACKGROUND

1. Field of Invention

The present invention relates to a control system and method. More particularly, the present invention relates to a system and method of controlling a heat dissipation gate.

2. Description of Related Art

A conventional laptop usually has a gate, fence, or outlet thereon such that the air can flow through the gate, fence, or outlet into the laptop to dissipate heat when the laptop is over heated and the fans therein are driven

However, the heat dissipation gate on the conventional laptop is designed to be immovable; that is, the size of the heat dissipation gate is fixed. Thus, users cannot select a range of sizes for the heat dissipation gate being open according to the operation of the laptop. Since the range of the heat dissipation gate being open cannot be controlled, dust or particles may spread and accumulate in the internal circuit of the laptop through the heat dissipation gate even when the laptop is powered off.

### SUMMARY

In accordance with one embodiment of the present invention, a heat dissipation gate control system of an electronic device is provided. The heat dissipation gate control system comprises a magnetic element, an electromagnetic element and an elastic element. The magnetic element is coupled to a heat dissipation gate. The electromagnetic element is provided for generating a magnetic force to enable the magnetic element to drive the heat dissipation gate open. The elastic element has an end coupled to the heat dissipation gate and applies an elastic force to the heat dissipation gate to enable the heat dissipation gate closed when the electromagnetic element stops generating the magnetic force for the magnetic element.

In accordance with another embodiment of the present invention, a method of controlling a heat dissipation gate of an electronic device is provided. The method comprises the steps of: arranging a magnetic element coupled to the heat dissipation gate; generating a magnetic force by an electromagnetic element; enabling the magnetic element by the magnetic force generated by the electromagnetic element to drive the heat dissipation gate open; and applying an elastic force to the heat dissipation gate by an elastic element to enable the heat dissipation gate closed when the electromagnetic element stops generating the magnetic force for the magnetic element.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference to the accompanying drawings as follows:

FIG. 1 illustrates a heat dissipation gate control system according to one embodiment of the present invention;

FIG. 2 illustrates a diagram of the electromagnetic element generating the repulsive force for the magnetic element according to one embodiment of the present invention;

FIG. 3 illustrates a diagram of the electromagnetic element generating the attractive force for the magnetic element according to one embodiment of the present invention;

FIG. 4 illustrates a heat dissipation gate control system according to another embodiment of the present invention;

FIG. 5 illustrates a block diagram of an internal control system of the laptop according to one embodiment of the present invention; and

FIG. 6 illustrates a flow chart of a method of controlling a heat dissipation gate according to one embodiment of the present invention.

### DESCRIPTION OF THE PREFERRED EMBODIMENTS

In the following detailed description, the embodiments of the present invention have been shown and described. As will be realized, the invention is capable of modification in various respects, all without departing from the invention. Accordingly, the drawings and description are to be regarded as illustrative in nature, and not restrictive.

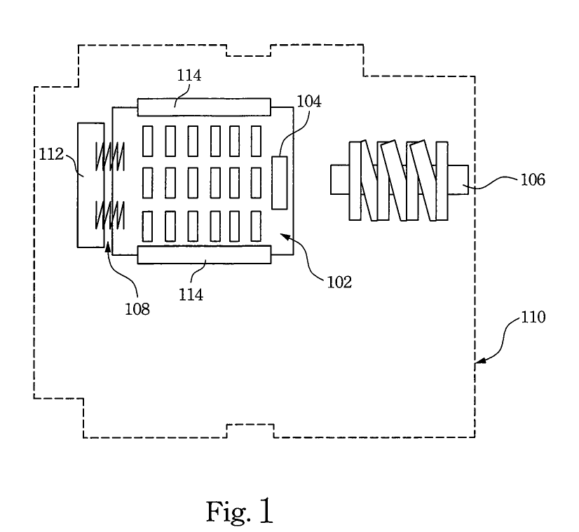

FIG. 1 illustrates a heat dissipation gate control system according to one embodiment of the present invention. The heat dissipation gate control system can be arranged on a base 110 of a laptop, so as to control a heat dissipation gate 102 of the base 110, for the fan to exhaust the air from the outside to dissipate heat generated by CPU or memory in the laptop. The heat dissipation gate control system includes a magnetic element 104, an electromagnetic element 106 and at least one elastic element, in which the elastic element can be a spring 108. The magnetic element 104 is coupled to the heat dissipation gate 102, such that the heat dissipation gate 102 can be moved along with the magnetic element 104, in which the magnetic element 104 can be a permanent magnet. The electromagnetic element 106 generates magnetic force, when the power is on, to enable the magnetic element 104 to move and to drive the heat dissipation gate 102 open, in which the electromagnetic element 106 can be an electromagnet. The spring 108 is coupled to the heat dissipation gate 102 and applies an elastic force to the heat dissipation gate 102 to enable the heat dissipation gate 102 to close when the electromagnetic element 106 stops generating the magnetic force for the magnetic element 104.

In addition, the spring 108 has an end coupled to the heat dissipation gate 102 and the other end capable of being fixed to a fixed block 112 connected with the base 110 or being fixed directly to the mechanism extended from the base 110. Moreover, the heat dissipation gate control system can further include two slides 114, one of which is independently arranged at one side of the heat dissipation gate 102, to fix moving direction of the heat dissipation gate 102 when the heat dissipation gate 102 is to be open.

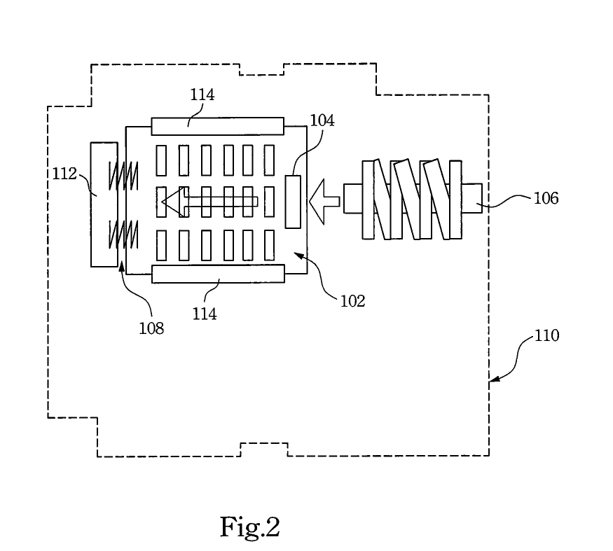

The electromagnetic element 106 can generate an attractive force or a repulsive force for the magnetic element 104 according to different power-on conditions, to enable the magnetic element 104 to drive the heat dissipation gate 102 open. Different power-on conditions will be explained as follows. FIG. 2 illustrates a diagram of the electromagnetic element generating the repulsive force for the magnetic element according to one embodiment of the present invention. When the electromagnetic element 106 generates the repulsive force for the magnetic element 104, the magnetic element 104 moves in the direction indicated by the arrow, and the heat dissipation gate 102 moves and opens in the same direction, such that the spring 108 is compressed. After that, when the electromagnetic element 106 stops generating the repulsive force for the magnetic element 104, the spring 108 generates the pushing force for the heat dissipation gate 102 to enable the heat dissipation gate 102 closed.

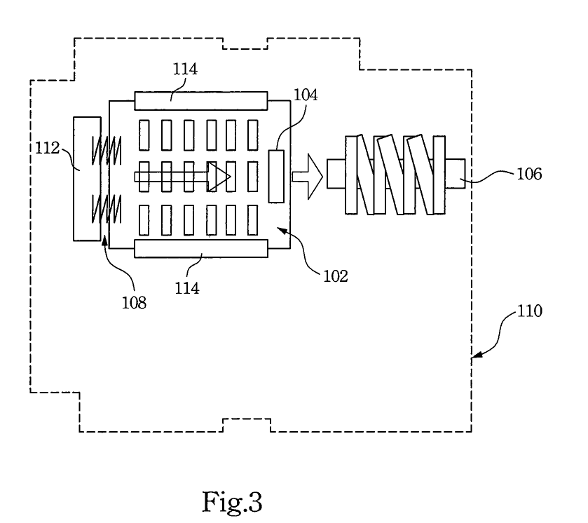

FIG. 3 illustrates a diagram of the electromagnetic element generating the attractive force for the magnetic element according to one embodiment of the present invention. When the electromagnetic element 106 generates the attractive force for the magnetic element 104, the magnetic element 104 moves and drives the heat dissipation gate 102 open in the direction indicated by the arrow, such that the spring 108 is stretched. After that, when the electromagnetic element 106 stops generating the attractive force for the magnetic element 104, the spring 108 generates the pulling force for the heat dissipation gate 102 to enable the heat dissipation gate 102 closed.

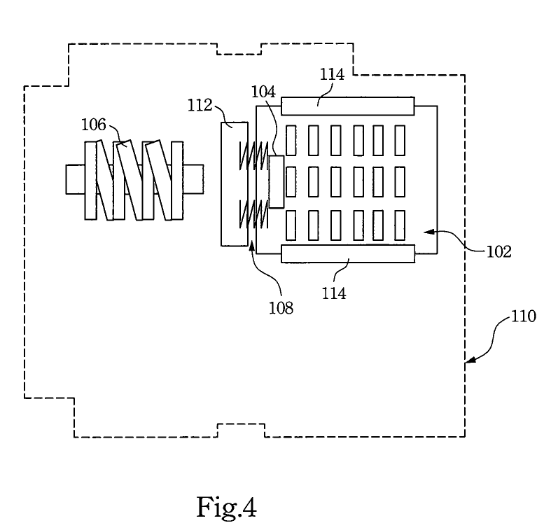

FIG. 4 illustrates a heat dissipation gate control system according to another embodiment of the present invention. Compared to FIG. 1, the electromagnetic element 106 and the magnetic element 104, in the present embodiment, are arranged at the other side of the heat dissipation gate 102. The electromagnetic element 106 can similarly generate the attractive or repulsive force for the magnetic element 104 as well according to different power-on conditions to enable the magnetic element 104 to move and drive the heat dissipation gate 102 open. Unnecessary details will not be given herein.

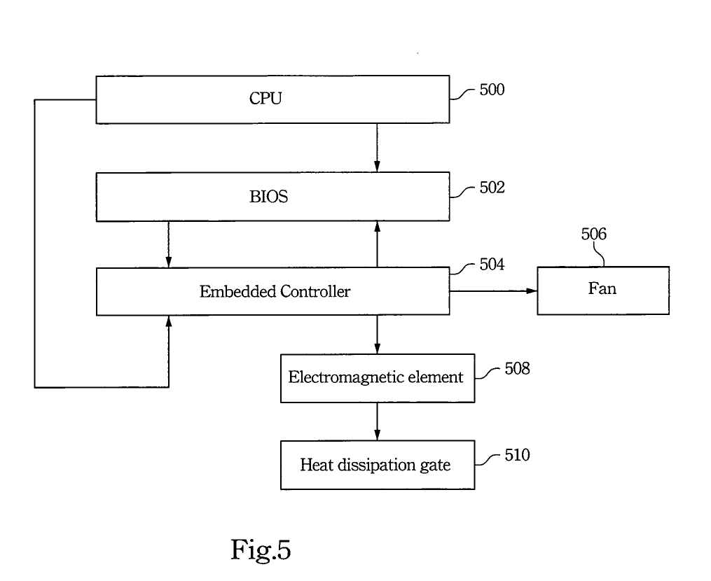

On the other hand, the range of the heat dissipation gate 102 being open can be determined by the power received by the electromagnetic element 106 when the power is on. FIG. 5 illustrates a block diagram of an internal control system of the laptop according to one embodiment of the present invention. First, the central processing unit (CPU) 500 transmits temperature signals, detected by heat sensor (not shown), to the basic input output system (BIOS) 502 and the embedded controller 504. Then, the BIOS 502 transmits a control command to the embedded controller 504 according to the received temperature signals. After that, the embedded controller 504 controls the rotation speed of the fan 506 with the power transmitted to the fan 506 according to the control command and the received temperature signals, and also transmits a regulating command back to the BIOS 502 when the temperature needs to be regulated, in which the power transmitted to the fan 506 can be a voltage or a current. At the moment, the embedded controller 504 controls the electromagnetic element 508 at the same time as well, so as to adjust the power transmitted to the electromagnetic element 508 to regulate the range of the heat dissipation gate 510 being open, in which the power transmitted to the electromagnetic element 508 also can be a voltage or a current. As a result, the rotation speed of the fan 506 and the range of the heat dissipation gate 510 being open can be simultaneously controlled according to different operations and internal temperatures of the laptop.

The following Table I shows the comparisons of different voltages, rotation speeds of the fan and sound pressure levels under different states of the fan and the electromagnetic element according to one embodiment of he present invention.

TABLE I

| | | | | voltage of |
|---|---|---|---|---|
| | fan | | sound | electromagnetic |
| | rotation speed | voltage | pressure level | element |
| Fan state | (RPM) | (V) | (dBA) | (V) |
| turn off | 0 | — | — | — |
| 1^{st} state | 2100 | 2.5 | 29 | — |
| 2^{nd} state | 2500 | 2.8 | 32 | 2.0 |
| 3^{rd} state | 2900 | 3.3 | 35 | 2.5 |
| 4^{th} state | 3300 | 3.9 | 38 | 3 |
| 5^{th} state | 3600 | 4.4 | 40 | 3.5 |
| 6^{th} state | 3600 | 4.9 | 40 | 4 |

First, when the laptop is not powered on yet, the fan turns off. At that moment, the rotation speed of the fan is 0, and the heat dissipation gate closes as well. Then, when the laptop is powered on, the fan is in the 1st state; that is, the fan receives the voltage to rotate. At the moment, however, the electromagnetic element still fails to receive the voltage to enable the heat dissipation gate open. Thus, the fan would exhaust the air inside the laptop to dissipate heat.

Moreover, when the inner temperature of the laptop gradually increases, the fan turns to the 2nd state; that is, the fan would receive the higher voltage such that the rotation speed increases. At the moment, the electromagnetic element also starts to receive the voltage to generate the magnetic force such that the heat dissipation gate is open. Afterward, the fan and the electromagnetic element would receive another higher voltage according to the temperature required to be regulated, so that the fan can rotate faster and the range of the heat dissipation gate being open can increase (i.e. 3rd, 4th, 5th, and 6th state). In addition, in another embodiment, the fan together with the electromagnetic element can be preconfigured to receive voltages at the same time, so that the heat dissipation gate also can be driven to open at the same time when the fan starts to rotate. In yet another embodiment, the voltage received by the fan is proportional to the voltage received by the electromagnetic element, or even as same as the voltage received by the electromagnetic element.

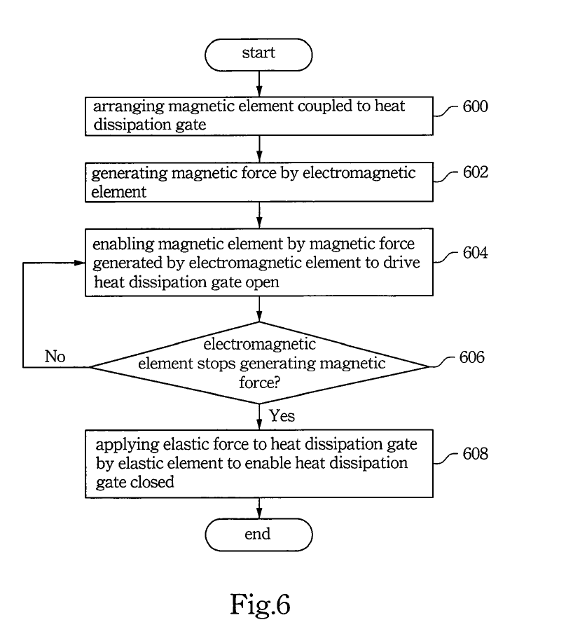

FIG. 6 illustrates a flow chart of a method of controlling a heat dissipation gate according to one embodiment of the present invention. First, a magnetic element is arranged to couple to a heat dissipation gate (Step 600), in which the arranged magnetic element can be a permanent magnet. Then, a magnetic force is generated by an electromagnetic element (Step 602), in which the electromagnetic element can be an electromagnet. After that, the magnetic element is enabled by the magnetic force generated by the electromagnetic element to drive the heat dissipation gate open (Step 604). The magnetic force generated by the electromagnetic element in Step 604 can be an attractive or a repulsive force. Furthermore, when the magnetic force is generated by the electromagnetic element for the magnetic element, the voltage or current received by the electromagnetic element can be regulated according to different operations or temperatures of the laptop, so as to control the magnetic force generated by the electromagnetic element and to regulate the range of the heat dissipation gate being open.

Afterward, whether the electromagnetic element stops generating the magnetic force or not is determined (Step 606). If the electromagnetic element does not stop generating the magnetic force, the heat dissipation gate will maintain open in accordance with the conditions of the magnetic element enabled by the magnetic force. On the other hand, if the electromagnetic element stops generating the magnetic force for the magnetic element, an elastic force can be applied to the heat dissipation gate by an elastic element to enable the heat dissipation gate to close (Step 608).

For the foregoing embodiment, the system and method of controlling the heat dissipation gate can be applied to keep dust or particles from entering the laptop when the laptop is not powered on, and to regulate the range of the heat dissipation gate being open according to the operations or temperatures of different elements (e.g. CPU, memory or laptop case) in the laptop when the laptop is powered on, so as to regulate the inner temperature of the laptop.

As is understood by a person skilled in the art, the foregoing embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A heat dissipation gate control system of an electronic device, comprising:
a magnetic element coupled to a heat dissipation gate;
an electromagnetic element for generating a magnetic force to enable the magnetic element to drive the heat dissipation gate open; and
an elastic element having an end coupled to the heat dissipation gate and applying an elastic force to the heat dissipation gate to enable the heat dissipation gate closed when the electromagnetic element stops generating the magnetic force for the magnetic element.

2. The heat dissipation gate control system of claim 1, wherein the electromagnetic element is connected to an embedded controller providing a first power for the electromagnetic element to generate the magnetic force.

3. The heat dissipation gate control system of claim 2, wherein a range of the heat dissipation gate being open is determined by the first power for the electromagnetic element.

4. The heat dissipation gate control system of claim 3, wherein the embedded controller provides a second power for a fan, to dissipate heat, of the electronic device.

5. The heat dissipation gate control system of claim 4, wherein the first power is proportional to the second power.

6. The heat dissipation gate control system of claim 5, wherein the first power is a voltage or a current.

7. The heat dissipation gate control system of claim 5, wherein the second power is a voltage or a current.

8. The heat dissipation gate control system of claim 1, further comprising:
at least one slide arranged at one side of the heat dissipation gate to fix moving direction of the heat dissipation gate.

9. The heat dissipation gate control system of claim 1, wherein the electromagnetic element generates an attractive force for the magnetic element to drive the heat dissipation gate open.

10. The heat dissipation gate control system of claim 1, wherein the electromagnetic element generates a repulsive force for the magnetic element to drive the heat dissipation gate open.

11. The heat dissipation gate control system of claim 1, wherein the electromagnetic element is an electromagnet.

12. The heat dissipation gate control system of claim 1, wherein the magnetic element is a permanent magnet.

13. The heat dissipation gate control system of claim 1, wherein the elastic element has the other end coupled to a base of the electronic device.

14. A method of controlling a heat dissipation gate of an electronic device, comprising:
arranging a magnetic element coupled to the heat dissipation gate;
generating a magnetic force by an electromagnetic element;
enabling the magnetic element by the magnetic force generated by the electromagnetic element to drive the heat dissipation gate open; and
applying an elastic force to the heat dissipation gate by an elastic element to enable the heat dissipation gate closed when the electromagnetic element stops generating the magnetic force for the magnetic element.

15. The method of controlling the heat dissipation gate of claim 14, wherein the electromagnetic element is connected to an embedded controller providing a first power for the electromagnetic element to generate the magnetic force.

16. The method of controlling the heat dissipation gate of claim 15, wherein a range of the heat dissipation gate being open is determined by the first power for the electromagnetic element.

17. The method of controlling the heat dissipation gate of claim 16, wherein the embedded controller provides a second power for a fan for the electronic device to have heat dissipation ability.

18. The method of controlling the heat dissipation gate of claim 17, wherein the first power is proportional to the second power.

19. The method of controlling the heat dissipation gate of claim 18, wherein the first power is a voltage or a current.

20. The method of controlling the heat dissipation gate of claim 18, wherein the second power is a voltage or a current.

21. The method of controlling the heat dissipation gate of claim 14, wherein the magnetic force is an attractive force.

22. The method of controlling the heat dissipation gate of claim 14, wherein the magnetic force is a repulsive force.

23. The method of controlling the heat dissipation gate of claim 14, wherein the electromagnetic element is an electromagnet.

24. The method of controlling the heat dissipation gate of claim 14, wherein the magnetic element is a permanent magnet.

25. The method of controlling the heat dissipation gate of claim 14, wherein the elastic element has an end coupled to a base of the electronic device.
